(19) United States
(12) Patent Application Publication
(10) Pub. No.: US 2013/0290547 A1
(43) Pub. Date: Oct. 31, 2013

(54) SYSTEM FOR MANAGING PERSISTENT CONNECTIONS

(71) Applicants: Alan C. Berkema, Granite Bay, CA (US); Banavara Madhusudan, Bangalore Karnataka (IN)

(72) Inventors: Alan C. Berkema, Granite Bay, CA (US); Banavara Madhusudan, Bangalore Karnataka (IN)

(21) Appl. No.: 13/455,763

(22) Filed: Apr. 25, 2012

(51) Int. Cl. G06F 15/16

(52) U.S. Cl. 709/227

(57) ABSTRACT

A system for managing persistent connections includes a network and a first device to administer persistent connections of other devices to the network. The system also includes a processor and a database to store information related to each existing persistent connection. The system further includes a non-transitory computer-readable storage medium including instructions causing the processor to: control the first device to establish a persistent connection between a second device and the network, determine whether the second device connection is an additional persistent connection or an existing persistent connection, analyze the information for each existing persistent connection to determine whether the system has reached a maximum number of existing persistent connections, remove information related to one of the existing persistent connections based on a predetermined rule when the system has reached the maximum number of existing persistent connections, and record information related to the second device persistent connection.

### BACKGROUND

Consumers appreciate network connectivity that is easy to use. They also appreciate the ability to quickly access networks, Businesses may, therefore, endeavor to create networks directed toward one or more of these objectives.

### BRIEF DESCRIPTION OF THE DRAWINGS

The following detailed description references the drawings, wherein:

FIG. 1 is an example of a system for managing persistent connections.

FIG. 2 is an example of information related to each existing persistent connection to a network stored in database of the system of FIG. 1.

FIG. 3 is an example of the information in a table of FIG. 2 with the establishment of an additional persistent connection, representing a maximum number of persistent connections that may be established for the system of FIG. 1.

FIG. 4 is an example of a rule or procedure for establishing an additional new persistent connection for the system of FIG. 1.

FIG. 5 is an example of an updated table of the database of persistent network connections of the system of FIG. 1.

FIG. 6 is an example of a method for managing persistent connections on a network.

FIG. 7 is an example of a device that may be utilized with the system of FIG. 1.

FIG. 8 is an example of a stand-alone wireless or Wi-Fi direct system topology.

FIG. 9 is another example of a stand-alone wireless or Wi-Fi direct system topology.

FIG. 10 is an example of a network topology utilizing two wireless local area networks and a wired local area network.

### DETAILED DESCRIPTION

When users of two or more devices want to create a network connection, their devices need to exchange discovery information or engage in a discovery protocol that allows them to locate one another. This involves exchanging configuration information and also agreement on a common communication channel. Security keys or credentials are then exchanged, for example, by each device user entering a personal identification number and/or password.

A one-time or non-persistent connection requires that devices execute the discovery protocol or exchange discovery information each time a network connection is established which can be time consuming. Additionally, such one-time or non-persistent connections require the users of the devices to re-enter their security credentials or keys as well, which is also time consuming and can be frustrating for some users, particularly when they can't remember their credentials or enter them incorrectly,

A persistent connection, on the other hand, requires that the devices exchange discovery information or execute the discovery protocol only one time during the establishment of the first network connection. Subsequent connections between these devices do not require this discovery protocol which saves time. Additionally, such persistent connections only require the users of the devices to enter their security keys or credentials once during establishment of the initial network connection, which also saves time as well as user frustration.

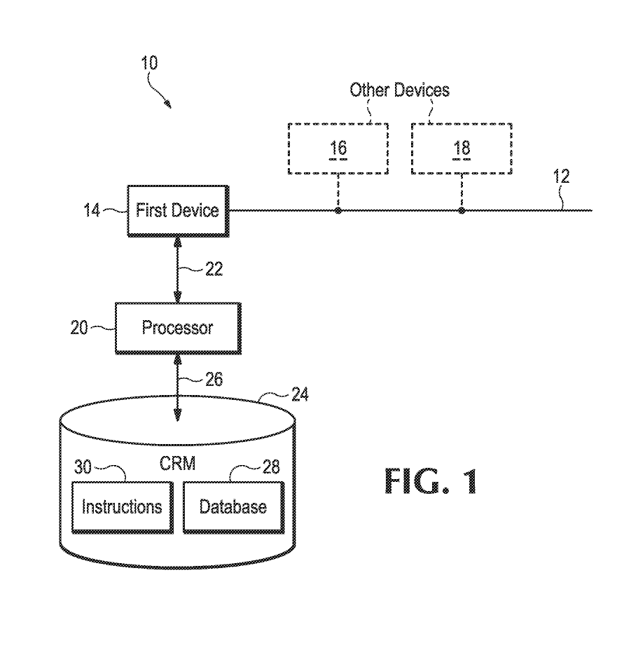

Implementing persistent connections requires network system resources, such as memory. The amount of resources available in a particular network system is often finite. Efficient use of these resources is, therefore, desirable. An example of a system for managing persistent connections 10 directed to these objectives is shown in FIG. 1.

As used herein, the terms “non-transitory storage medium” and non-transitory computer-readable storage medium” are defined as including, but not necessarily being limited to, any media that can contain, store, or maintain programs, information, and data. Non-transitory storage medium and non-transitory computer-readable storage medium may include any one of many physical media such as, for example, electronic, magnetic, optical, electromagnetic, or semiconductor media. More specific examples of suitable non-transitory storage medium and non-transitory computer-readable storage medium include, but are not limited to, a magnetic computer diskette such as floppy diskettes or hard drives, magnetic tape, a random access memory (RAM), a read-only memory (ROM), an erasable programmable read-only memory (EPROM), a flash drive, a compact disc (CD), or a digital video disk (DVD).

As used herein, the term “processor” is defined as including, but not necessarily being limited to, an instruction execution system such as a computer/processor based system, an Application Specific Integrated Circuit (ASIC), or a hardware and/or software system that can fetch or obtain the logic from a non-transitory storage medium or a non-transitory computer-readable storage medium and execute the instructions contained therein, “Processor” can also include any controller, state-machine, microprocessor, cloud-based utility, service or feature, or any other analogue, digital and/or mechanical implementation thereof.

As used herein, “device” is defined as including, but not necessarily being limited to, any electronic or electrical apparatus that may need to access or receive data or information from a network, such as a computer, server, mainframe, cell phone, mobile phone, personal digital assistant (PDA), tablet, telephone, radio, television, mobile music player, camera, sports equipment such as a heart rate monitor, medical monitoring equipment, etc. “Database” is defined as including, but not necessarily being limited to, an organized collection of information or data. This information may be stored in a digital and/or analogue format, for example on a non-transitory storage medium, so that it is readily retrievable as needed. The database may be updated by authorized users and may also be archived or otherwise backed-up in the event of loss,

As used herein, “network” is defined as including, but not necessarily being limited to, a collection or combination of hardware and/or software components or elements that are interconnected by communication channels that allow sharing of resources and information. These communication channels can be wired, wireless, optical, or any combination thereof. Where at least one process in one device is able to send/receive data to/from at least one process residing in a remote device, then the two devices are said to be in a network.

A “persistent network connection” is defined as including, but not being limited to, a network connection between two or more devices where certain items, such as discovery information, connection identifiers, and credentials, are retained or stored, for example in a database, for subsequent connections, This retention or storage negates the need for these items to be reentered by a user each time connection to the network is reestablished.

As can be seen in FIG. 1, system 10 includes a network 12 and a first device 14 to administer persistent connections of other devices 16 and 18 to network 12, System 10 also includes a processor 20 coupled to first device 14, as indicated by double-headed arrow 22, and a non-transitory computer-readable storage medium 24 coupled to processor 20, as indicated by double-headed arrow 26, so that processor 20 is able to read information from and write information to medium 24, Non- transitory computer-readable storage medium 24 includes a database 28 that stores information related to each existing persistent connection to network 12, as discussed in more detail below. As can be further seen in FIG. 1, database 28 is stored on or a part of non- transitory computer-readable storage medium 24. It is to be understood, however, that in other embodiments of system 10, database 28 may be separate from non-transitory computer-readable storage medium 24.

Non-transitory computer-readable storage medium 24 includes instructions 30 that, when executed by processor 20, cause processor 20 to control first device 14 to establish a persistent connection between a second device, such as other device 16 or other device 18, and network 12, Instructions 30 also cause processor 20 to determine whether the second device connection is an additional persistent connection to network 12 or an existing persistent connection to network 12. These instructions also cause processor 20 to analyze the information stored in database 28 for each existing persistent connection to network 12 to determine whether system 10 has reached a maximum number of existing persistent connections to the network 10 due to constraints such as limited system 10 memory.

Instructions 30 additionally cause processor 20 to remove information from database 28 related to either an existing persistent connection to network 12 based on a predetermined rule when system 10 has reached the maximum number or existing persistent connections to network 10, as discussed in more detail below. Instructions 30 further cause processor 20 to record information in database 28 related to the persistent connection of the second device to network 12, as also discussed in more detail below.

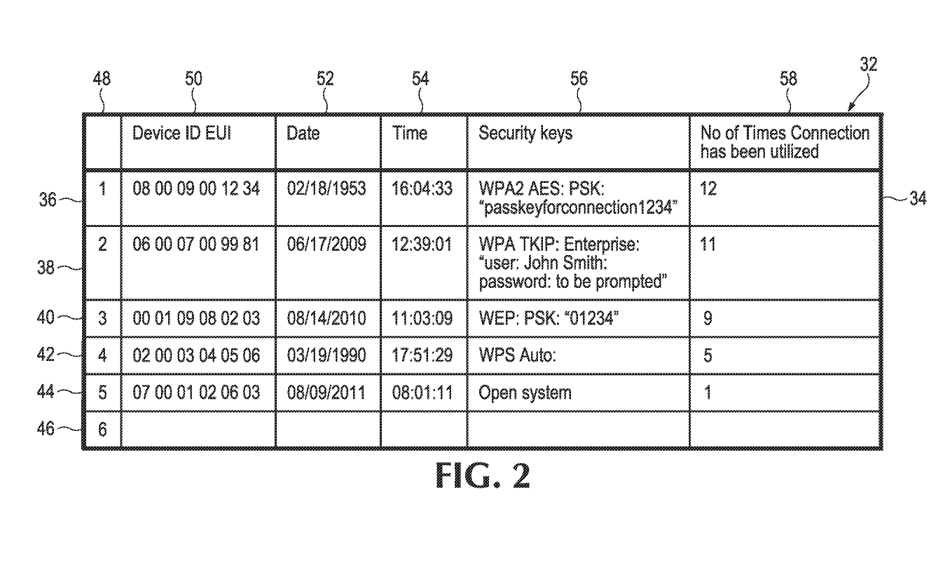

An example of the information 32 related to each existing persistent connection to network 12 stored in database 28 is shown FIG. 2. As can be seen in FIG. 2, in this example, database information 32 is in the form of a table 34 having a number of rows 36, 38, 40, 42, 44, and 46 (in this example six (6)) each of which represents information regarding one persistent connection to network 12. Although six (6) rows 36, 38, 40, 42, 44, and 46 of information for database 28 are shown in FIG. 2, it is to be understood that other examples of table 34 may include fewer than six (6) rows or more than six (6) rows, As can also be seen in FIG. 2, table 34 includes a number of columns 48, 50, 52, 54, 56, and 58 (in this example six (6)) each of which represents different data or information regarding one of the persistent connections to network 12. Although six (6) columns 48, 50, 52, 54, 56, and 58 of information for each row 36, 38, 40, 42, 44, and 46 are shown in FIG. 2, it is to be understood that other examples of table 34 may include fewer than six (6) columns or more than six (6) columns, depending on the amount of data or information needed to be stored for each persistent connection.

In the example of table 34 shown in FIG. 2, there are currently five persistent connections on network 12 of system 10, the data or information for each being stored in entries or rows 36, 38, 40, 42, and 44. Row or entry 46 is currently empty meaning that system 10 can establish another persistent connection with a device. In table 34, the number (e.g., one (1) through six (6)) of each persistent connection is stored in column 48. A device identifier (ID), such as an Extended Unique Identifier (EUI), is stored in column 50. The date (i.e., month, day and year) of each persistent connection is stored in column 52 and the time (i.e., hour, minute, and second) of each persistent connection is stored in column 54. Security keys or credentials for each persistent connection are stored in column 56. The number of times a persistent connection has be utilized since its inception is stored in column 58.

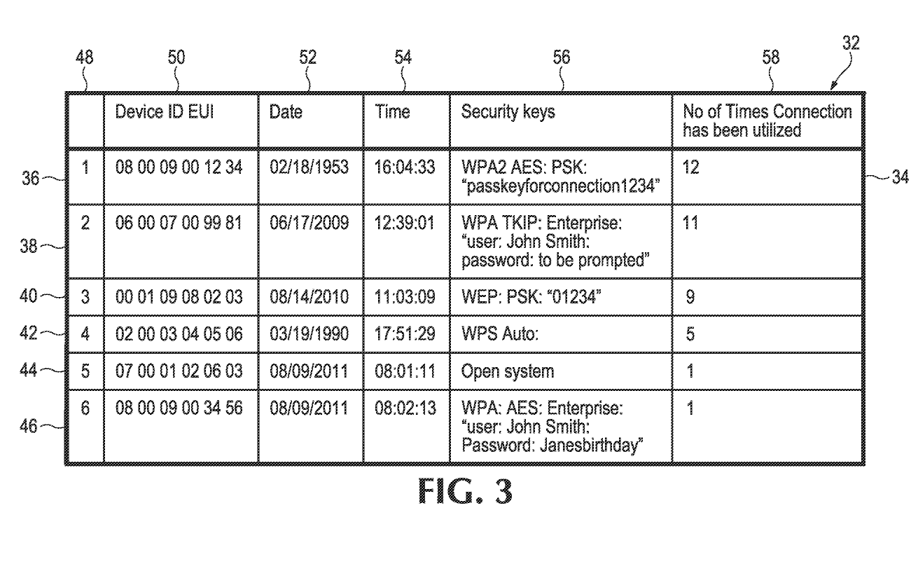

FIG. 3 shows an example of the information 32 in table 34 of database 28 with the establishment of an additional sixth (6^{th}) persistent connection, as represented by the data in row 46. In this example, this represents the maximum number of persistent connections that may be established for system 10. When a next additional persistent connection needs to be established for system 10, an additional entry in table 34 for that connection is not present. As least two possibilities exist in this case, either the additional new persistent connection is not allowed to be established, which may lead to end user dissatisfaction, or this additional new persistent connection is allowed according to some established system 10 rule or procedure.

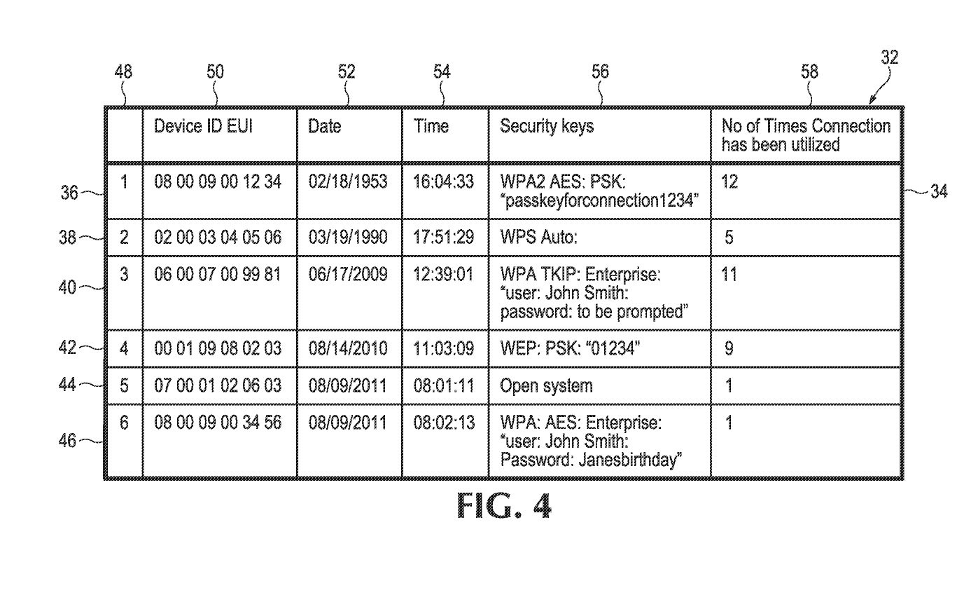

An example of such a rule for system 10 is shown in FIG. 4. In this example, the rule proscribes that one of the existing persistent connections is removed to make room for the additional new persistent connection by first sorting table 34 from the oldest of the existing persistent connections stored therein at the beginning of table 34 in entry or row 1 (36) to the newest of the existing persistent connections stored therein at the end of table of 34 in entry or row 6 (46). In this example, the rule also dictates that the oldest existing persistent connection that has been utilized the least is removed from table 34 and the associated device disconnected from network 12. In this case, the persistent connection represented by the data or information in entry or row 2 (38) is both the oldest and least utilized of those currently stored in table 34 of database 28.

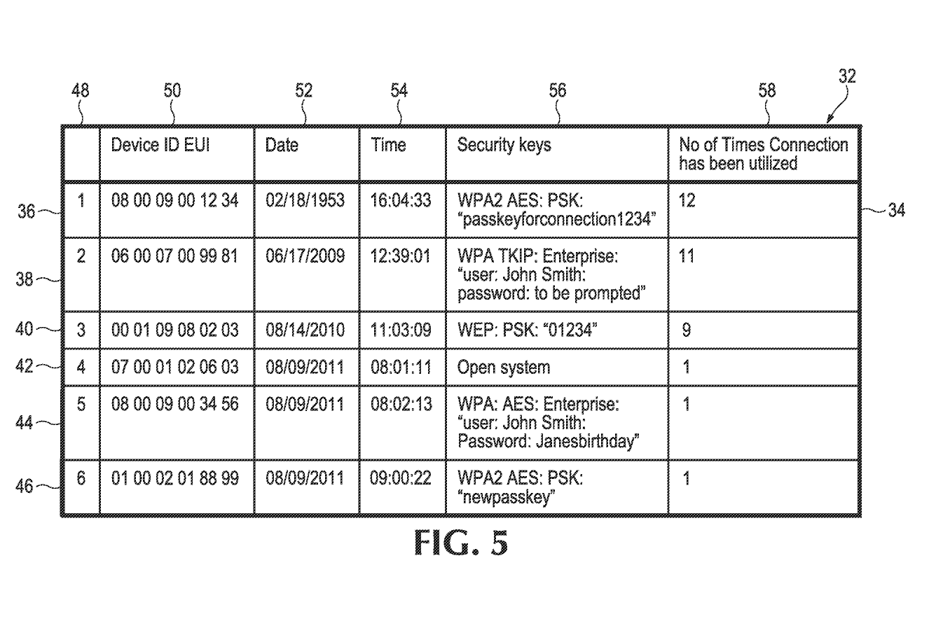

As can be seen in the updated table 34 of database 28 shown in FIG. 5, the entries in rows 40, 42, 44, and 46 of table 34 shown in FIG. 4 representing the still existing persistent connections to network 12 move up to rows 38, 40, 42 and of 44 of table 34 shown in FIG. 5. Also, information or data for the additional new persistent connection to network 12 is stored in row or entry 6 (46) of table 34 of database 28.

Each of entries 36, 38, 40, 42, 44, and 46 in table 34 can be defined as a “token” for a persistent connection to network 12. As such, these tokens can be stored in a file format such as xml or a simple set of ASCII characters delimited by special characters (e.g., a comma “,”) between each parameter in a token, as well as between each token itself. This allows sets of users to automatically create and join a persistent connection by sharing a corresponding token, for example via e-mail or SMS, using asymmetric encryption (public/private key mechanism) for security. Recipients of these tokens can configure their devices to automatically connect to network 12 using the parameters stored in the token.

Although the tokens illustrated by each of entries 36, 38, 40, 42, 44, and 46 are for persistent connections, it is to be understood that other tokens may be used for system 10 that are for non-persistent or one-time connections. Furthermore, tokens for system 10 can also include other information about a connection (whether persistent or non-persistent) such as one or more of the following: SSID, BSSID, channel number, af/sta/wifi-direct abilities, supported rates, long/short preamble, 11n feature support parameters (AMSDU, AMPDU aggregations, greenfield mode), and token specific information.

Token specific information can be used to automatically launch certain applications. For example, a user of system 10 may want to multicast a video to others, so the user creates a token with token specific information that contains the media player application name, media server URL, command to play at a particular time, etc. When the connection token is invoked, the media player launch can be automated on a device, as well as automate connection to the media server of the user and playing of the video using the token specific information. As this example illustrates and as discussed above, a token can be broadly defined as a collection of connection-specific information elements.

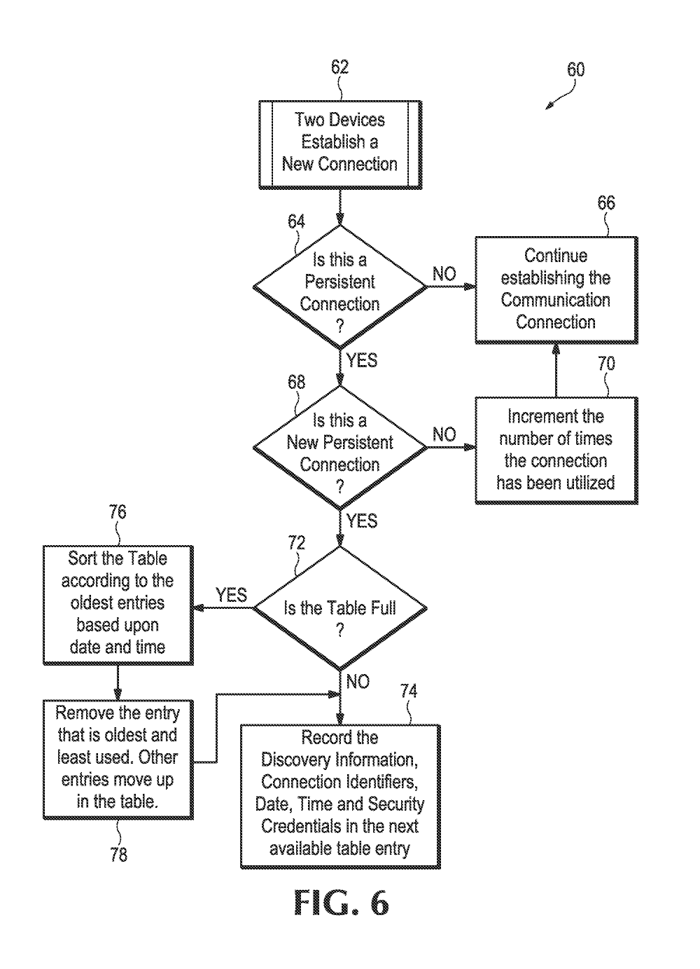

An example of a method for managing persistent connections on a network 60 is shown in FIG. 6, As can be seen in FIG. 6, method 60 begins with two devices establishing a new connection, as indicated by block 62. Next, method 60 determines whether the new connection is a persistent connection 64. If not, then method 60 continues by establishing the non-persistent connection as indicated by block 66, If it is a persistent connection, then method 60 continues by determining whether it is a new persistent connection 68, If not, then method 60 increments the number of times the connection has been utilized, as indicated by block 70, for example, in table 34 of database 28, as discussed above.

If it is a new persistent connection, then method 60 continues by determining if table 34 of database 28 is full 72. If not, then method 60 records information or data relating to the new persistent connection in table 34, such as the above-described discovery information, connection identifiers, date and time of the initial connection, and security credentials, as indicated by block 74. If table 34 is full, then method 60 continues by sorting table 34 according to the oldest entries based upon date and time, as indicated by block 76. Next, method 60 removes the entry or token that is the oldest and least used, as indicated by block 78. Method 60 also moves the other entries or tokens up in table 34, as additionally indicated by block 78. Finally, method 60 records information or data relating to the new persistent connection in table 34, such as the above-described discovery information, connection identifiers, date and time of the initial connection, and security credentials, as indicated by block 74.

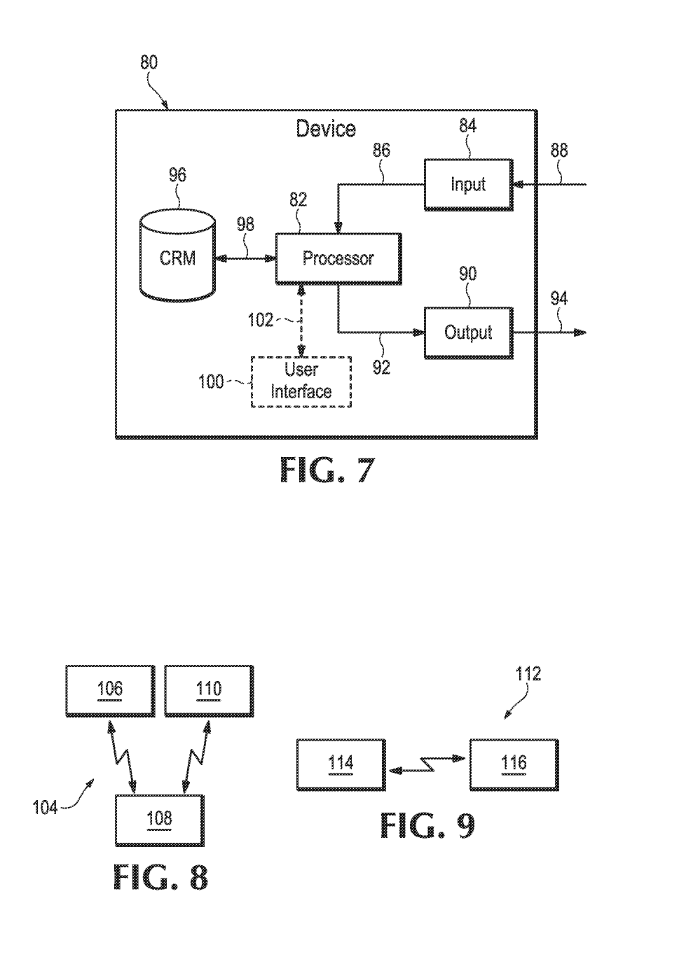

FIG. 7 is an example of a device 80 that may be utilized with system 10. As discussed above, device 80 may include any electronic or electrical apparatus that may need to access or receive data or information from network 12 of system 10. As can be seen in FIG. 7, device 80 includes a processor 82 coupled to an input 84, as indicated by arrow 86. Input 84 is designed to receive data from and interface with network 12, as indicated by arrow 88. Device 80 additionally includes an output 90 coupled to processor 82, as indicated by arrow 92. Output 90 is designed to transmit data to and interface with network 12, as indicated by arrow 94,

As can also be seen in FIG. 7, device 80 includes a non-transitory computer-readable storage medium 96 that is coupled to processor 82, as indicated by double-arrow 98. Non-transitory computer-readable storage medium 96 includes instructions that are executed by processor 82 to control the functioning of device 80. Depending on the type of functionality provided by device 80, it may additionally include a user interface 100 that is coupled to processor 82, as indicated by double-arrow 102, User interface 100 may include a display for communicating information to an end user and an input section for allowing an end user to enter data or information. It may also include other features and functionality, such as, for example, a speaker and microphone.

The above-described system for managing persistent connections and associated method may be used with any of a variety of network technologies. For example, as shown in FIG. 8, a stand-alone wireless or Wi-Fi direct system topology 104. The example of system 104 shown in FIG. 8 includes a computer 106, a wireless access point (WAP) 108, and a peripheral device 110, such as a printer.

Another example of a stand-alone wireless or Wi-Fi direct system topology 112 that may utilize the system for managing persistent connections and associated method is shown in FIG. 9. As can be seen in FIG. 9, in this example system 112 includes a mobile phone 114 and a tablet 116 that are sharing data over a wireless link.

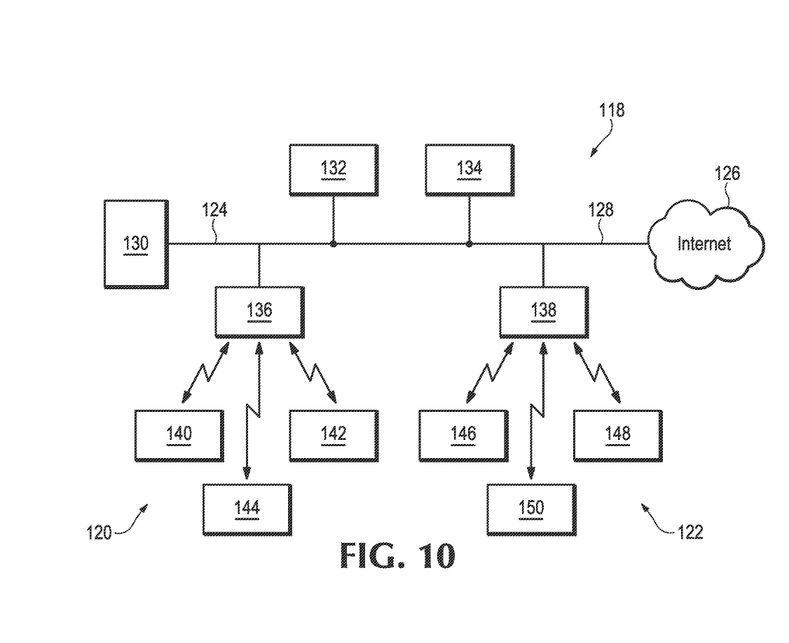

An example of a network system 118 topology utilizing two wireless local area networks 120 and 122 and a wired local area network 124 connected to internet 126 is shown in FIG. 10. As can be seen in FIG. 10, system 118 includes a wired network 128 on which a server 130 is connected to administer persistent connections to one or more devices, such as devices 132, 134, 136, and 138. In this example, devices 132 and 134 are computers and devices 136 and 138 are access points (e.g., wireless routers). As can also be seen in FIG. 10, wireless local area network 120 includes devices 140, 142, and 144 and wireless local area network 122 includes devices 146, 148, and 150. In this example, devices 140, 142, 144, 146, 148, and 150 may be any of the type discussed above. Although not shown, it is to be understood that additional devices may also establish persistent connections to system 118. Furthermore, one or more of these additional devices may instead establish a one-time or non-persistent connection.

The system for managing persistent connections and associated method may be used with any of a variety of different types of network topologies including those illustrated above, as well as mesh, ring, and tree topologies. Additionally, any of a variety of protocols may be used including, without limitation, TCP/IP, Bluetooth, 802.11, OSI, IPX/SPX, X.25, AX.25, and token-based. Furthermore, any of a variety of different transport media may be used included wire, cable, fiber optics, wireless, and photonics.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. For example, other connections of system 10 can be one-time or non-persistent as well. As another example, database information 32 may be stored in formats other than that of a table, such as a record, a multi-dimensional matrix, an array, a fiat file, a relational format, etc, As a further example, the rule or procedure for removing an existing persistent connection from a network to allow room for an additional new persistent connection can be based on things other than just the age and the number of times a particular persistent connection has been utilized, such as the extent of the security associated with of each connection, with the least secure being removed to protect the integrity of both the database and system. As yet a farther example, the rule or procedure for removing an existing persistent connection from a network to allow room for an additional new persistent connection may also take into account whether or not the persistent connection is currently connected to a network and in use. The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. A system for managing persistent connections, comprising: a network;
a first device to administer persistent connections of other devices to the network; a processor coupled to the first device;
a database to store information related to each existing persistent connection to the network; and
a non-transitory computer-readable storage medium including instructions that, when executed by the processor, cause the processor to:
control the first device to establish a persistent connection between a second device and the network,
determine whether the second device connection is one of an additional persistent connection to the network and an existing persistent connection to the network,
analyze the information in the database for each existing persistent connection to the network to determine whether the system has reached a maximum number of existing persistent connections to the network,
remove information from the database related to one of the existing persistent connections to the network based on a predetermined rule when the system has reached the maximum number of existing persistent connections to the network, and
record information in the database related to the persistent connection of the second device to the network.

2. The system of claim 1, wherein the non-transitory computer-readable storage medium further includes instructions that, when executed by the processor, cause the processor to control the first device to disconnect the one of the existing persistent connections to the network for the device whose information corresponds to the information removed from the database.

3. The system of claim 1 wherein the first device also administers at least one non-persistent connection of another device to the network.

4. The system of claim 1, wherein the predetermined rule includes ages of each of the persistent connections.

5. The system of claim 1, wherein the predetermined rule includes the number of times each persistent connection has been utilized.

6. The system of claim 1, wherein the information stored in the database relating to each existing persistent connection to the network includes connection identifiers and secure credentials,

7. The system of claim 1, wherein the information stored in the database relating to each existing persistent connection to the network includes at least one token.

8. A method for managing persistent connections on a network, comprising:
establishing a persistent connection on the network between two devices;
determining whether the persistent connection on the network between the two devices is one of an additional persistent connection and an existing persistent connection;
analyzing whether a maximum number of existing persistent connections to the network has been reached;
removing information from a database related to one of the existing persistent connections to the network based on a predetermined rule when the maximum number of existing persistent connections to the network has been reached; and
recording information in the database related to the persistent connection of the two devices.

9. The method of claim 8, disconnecting the one of the existing persistent connections to the network for a device whose information corresponds to the information removed from the database.

10. The method of claim 8, further comprising establishing a non-persistent connection on the network between one of the two devices and a third device.

11. The method of claim 8, wherein the predetermined rule includes ages of each of the persistent connections.

12. The method of claim 8, wherein the predetermined rule includes the number of times each persistent connection has been utilized.

13. The method of claim 8, further comprising recording information in the database relating to each existing persistent connection to the network

14. The method of claim 13, wherein the information recorded in the database includes connection identifiers and secure credentials,

15. A non-transitory computer-readable storage medium comprising instructions that, when executed by a processor, cause the processor to:
establish a persistent connection on a network between two devices;
determine whether the persistent connection on the network between the two devices is one of an additional persistent connection and an existing persistent connection;
analyze whether a maximum number of existing persistent connections to the network has been reached;
remove information from a database related to one of the existing persistent connections to the network based on a predetermined rule when the maximum number of existing persistent connections to the network has been reached; and
record information in the database related to the persistent connection of the two devices.

16. The non-transitory computer-readable storage medium of claim 15, further comprising instructions that, when executed by a processor, cause the processor to disconnect the one of the existing persistent connections to the network for a device whose information corresponds to the information removed from the database.

17. The non-transitory computer-readable storage medium of claim 15, further comprising instructions that, when executed by a processor, cause the processor to establish a non-persistent connection on the network between one of the two devices and a third device.

18. The non-transitory computer-readable storage medium of claim 15, wherein the predetermined rule includes ages of each of the persistent connections.

19. The non-transitory computer-readable storage medium of claim 15, wherein the predetermined rule includes the number of times each persistent connection has been utilized.

20. The non-transitory computer-readable storage medium of claim 15, further comprising instructions that, when executed by a processor, cause the processor to record information in the database relating to each existing persistent connection to the network.

21. The non-transitory computer-readable storage medium of claim 20, wherein the information recorded in the database includes connection identifiers and secure credentials.
